(19) United States
(12) Patent Application Publication
(10) Pub. No.: US 2013/0159206 A1
(43) Pub. Date: Jun. 20, 2013

(54) DYNAMIC VEHICLE ROUTING IN MULTI-STAGE DISTRIBUTION NETWORKS

(71) Applicants: Francisco Barahona, White Plains, NY (US); Peter M. Rimshnick, Hoboken, NJ (US); Maxim I. Sviridenko, New York, NY (US); Yichong Yu, Yorktown Heights, NY (US); Zhili Zhou, Gainesville, FL (US)

(72) Inventors: Francisco Barahona, White Plains, NY (US); Peter M. Rimshnick, Hoboken, NJ (US); Maxim I. Sviridenko, New York, NY (US); Yichong Yu, Yorktown Heights, NY (US); Zhili Zhou, Gainesville, FL (US)

(73) Assignee: INTERNATIONAL BUSINESS MACHINES CORPORATION, Armonk, NY (US)

(21) Appl. No.: 13/325,841

(22) Filed: Dec. 14, 2011

(51) Int. Cl. G06Q 50/28

(52) U.S. Cl. 705/338

(57) ABSTRACT

Determining a routing of vehicles for pickup and delivery in a supply chain network, in one aspect, may include generating a plurality of candidate set of routes for vehicles for pickup and delivery to meet demand at multiple target locations. Unsatisfied demand at said multiple target locations resulting from completing pickup and delivery according to the generated plurality of candidate set of routes may be determined. A set of vehicles routes are selected from said plurality of candidate set of routes that minimizes said unsatisfied demand across all said multiple target locations by applying an optimization function.

### STATEMENT REGARDING FEDERALLY SPONSORED RESEARCH OR DEVELOPMENT

This invention was made with Government support under Contract No.: HSFEHQ-07-F-1049 awarded by Federal Emergency Management Administration (FEMA). The Government has certain rights in this invention.

### FIELD

The present application relates generally to operations research and related automated computer applications, and more particularly to dynamic vehicle routing in multi-stage distribution networks.

### BACKGROUND

The pickup and delivery vehicle routing problem in both commercial applications and academic research works consider minimization of the traveling time as the objective function. They do not handle the dynamic vehicle routing problem (DVRP) in which the objective function maximizes the demand satisfaction with fairness.

Savelsbergh, M. W. P., M. Sol. 1995, The general pickup and delivery problem, Transportation Science 29 17-29, and Parragh, S., K. Doerner, R. Hartl, 2008, A survey on pickup and delivery problems, Journal fur Betriebswirtschaft 58 81-117, provides a survey of research works in vehicle routing problem areas. In these surveys, the authors compare the works by objective functions, major constraints, algorithms, and the scalability of problems. None of those works, however, treat DVRP with the objective function of maximizing the demand satisfaction with fairness.

Solution methods for solving an optimization problem include exact solution approaches, heuristic approaches, and meta-heuristic approaches. Branch-and-bound and column generation are two exact solution approaches to solving the pickup and delivery problem. The following research works solved pickup and delivery problems using branch-and-bound algorithms. Ruland, K S., E Y. Rodin. 1997, The pickup and delivery problem: Faces and branch-and-cut algorithm, Computers & Mathematics with Applications 1-13, generated cutting planes in the bounding phase and a greedy route construction procedure to obtain the first upper bound. Cordeau, J F. 2006, A branch-and-cut algorithm for the dial-a-ride problem, Operations Research 573-586, solved a single vehicle problem with the consideration of Last-In-First-Out loading rules. A column generation approach is also used in several works. Dumas, Y., J. Desrosiers, Soumis, F. 1991, The pickup and delivery problem with time windows, European Journal of Operational Research 7-22, considered pickup and delivery problem with heterogeneous vehicles, time-windows, and multiple depots with a shortest path based routing. Ropke, S., D. Pisinger, 2006, A unified heuristic for a large class of vehicle routing problems with backhauls, European Journal of Operational Research 750-775, introduced the branch-and-pricing algorithm with additional valid constraints.

Because the pickup and delivery problem is an NP hard problem, more research works related to the pickup and delivery problem are concentrated on the heuristic approach. Sexton, T R., Y M. Choi, 1986, Pickup and delivery of partial loads with soft time windows, American Journal of Mathematical and Management Sciences 369-398, used Bender's decomposition procedure to solve the problem approximately. van der Bruggen, L J J., J K. Lenstra, P C. Schuur. 1993, Variable-depth search for the single vehicle pickup and delivery problem with time windows 298-311, improved the heuristics algorithm by constructing a feasible solution as the initial solution and updated the solution by exchange procedures. Renaud, J., F F. Boctor, J. Ouenniche. 2000, A heuristic for the pickup and delivery traveling salesman problem, Computers & Operations Research 905-916, proposed a double insertion construction heuristic which was improved by deletion and reinsertion in the vehicle routing generation. Renaud, J., F F. Boctor, G. Laporte. 2002, Perturbation heuristics for the pickup and delivery traveling salesman problem, Computers & Operations Research 1129-1141, considered the same problem with seven different perturbation heuristics and generated near optimal solutions for the pickup and delivery problem. Xu, H., Z L. Chen, S. Rajagopal, S. Arunapuram. 2003, Solving a practical pickup and delivery problem, Transportation Science 347-364, proposed column generation based heuristics for multiple vehicle cases with multiple time-window constraints, loading restrictions, and driver working hours as the side constraints. Lu, Q., MM Dessouky. 2006, A new insertion-based construction heuristic for solving the pickup and delivery problem with time windows, European Journal of Operational Research 672-687, developed heuristics which considered both the distance and the time-window slack reduction.

In order to improve the quality of solutions, neighborhood search related meta heuristics have been discussed for the pickup and delivery problem. Carrabs, F., J F. Cordeau, G Laporte. 2007, Variable neighborhood search for the pickup and delivery traveling salesman problem with lifo loading, INFORMS Journal on Computing 618-632, tackled a problem by couple exchanges, block exchanges, etc. in the neighborhood search. Li, H., A. Lim, J. Huang. 2001, Local search with annealing-like restarts to solve the vrptw, Tech. rep., developed a tabu embedded simulated annealing approach based on a shift, an exchange, and rearrange operations. Pankratz, G. 2005, A grouping genetic algorithm for the pickup and delivery problem with time windows, OR Spectrum 21-41, proposed a grouping genetic algorithm by the cluster of requests forming a route. Ropke, S., J F. Cordeau. 2009, Branch and cut and price for the pickup and delivery problem with time windows, Transportation Science 43(3) 267-286, presented an adaptive neighborhood search algorithm. Bent, R., P. van Hentenryck. 2006, A two-stage hybrid algorithm for pickup and delivery vehicle routing problems with time windows, Computers & Operations Research 33 875-893, provided a two-state hybrid algorithm with a simulated annealing first stage and large neighborhood search based second stage. Derigs, U., T. Dohmer. 2008, Indirect search for the vehicle routing problem with pickup and delivery and time windows, OR Spectrum 149-165, discussed an indirect local search by separating securing feasibility from the neighborhood search process.

### BRIEF SUMMARY

A method of determining a routing of vehicles for pickup and delivery in a supply chain network, in one aspect, may include generating a plurality of candidate set of routes for vehicles for pickup and delivery to meet demand at multiple target locations. The method may also include determining unsatisfied demand at multiple target locations resulting from completing pickup and delivery according to the plurality of candidate set of routes. The method may further include selecting a set of vehicles routes from the plurality of candidate set of routes that minimizes the unsatisfied demand across all multiple target locations by applying an optimization function.

A system of determining a routing of vehicles for pickup and delivery in a supply chain network, in one aspect, may include a processor operable to generate a plurality of candidate set of routes for vehicles for pickup and delivery to meet demand at multiple target locations. The processor may be further operable to determine unsatisfied demand at multiple target locations resulting from completing of the pickup and delivery according to the plurality of candidate set of routes. The processor may be further operable to select a set of vehicles routes from the plurality of candidate set of routes that minimizes unsatisfied demand across all multiple target locations by applying an optimization function.

A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE SEVERAL VIEWS OF THE DRAWINGS

FIG. 1 illustrates a time-space network/departure network for a lower demand case of DVRP.

FIG. 2 illustrates a four-level distribution network example.

FIG. 3 illustrates a flow chart of algorithm design in one embodiment of the present disclosure for dynamic vehicle routing in multi-stage distribution networks with multiple sourcing and delivery constraints.

FIG. 4 illustrates the flow chart of the greedy algorithm design in one embodiment of the present disclosure.

FIG. 5 illustrates an overview of an example supply chain network in which dynamic vehicle routing algorithms of the present disclosure may be applied.

FIG. 6 illustrates an example of areas of coverage without fairness.

FIG. 7 illustrates meeting demand according to two different objectives.

FIG. 8 illustrates an example of improvement in fairness.

FIG. 9 illustrates a schematic of an example computer or processing system that may implement the dynamic vehicle routing system in one embodiment of the present disclosure.

### DETAILED DESCRIPTION

A hierarchical approach is disclosed in one embodiment of the present disclosure to solve vehicle routing problems. Routing problems may apply in a large-scale complicated system in multi-stage distribution networks, with multiple sources, multiple transshipping points, dynamic delivery targets, and time-dependent traveling distance. Routing problems in one embodiment of the present disclosure are solved to maximize demand satisfaction with fairness in coverage areas. Different algorithms are developed for this problem with different tradeoffs of computational time and precision.

In the present disclosure in one embodiment, a dynamic vehicle routing problem (DVRP) in multi-stage distribution networks with multiple sources and delivery constraints is solved to maximize the demand fulfillment in delivery locations with fairness. This problem can be categorized as a pickup and delivery vehicle routing problem, a type of vehicle routing problem, where goods are transported between pickup and delivery locations. Solutions in one embodiment of the present disclosure schedule and assign multiple types of vehicles to pickup and deliver commodities among locations in different levels of distribution networks.

In one embodiment, the DVRP algorithms of the present disclosure accept as inputs distribution networks, transportation networks, the information about pickup/delivery commodities and delivery vehicles. Distribution networks are multiple-level networks, which include locations in different levels of networks. Transportation networks provide the information of connectivity and corresponding distance among locations in distribution networks. The information about pickup/delivery commodities shows the detailed location, available time, and requested time of commodities. Vehicle information is the location and time of availability of each vehicle in the system. Because multiple vehicles are able to pickup commodities from multiple locations, DVRP solves a problem with multiple sources for commodities and vehicles. Multiple locations in distribution networks are transshipment points, where the shipment of commodities goes to and then departs from to another destination.

In the DVRP instance of the present disclosure, the connectivity and distance among locations in transportation networks could be time-dependent. For instance, two locations in the transportation network are connected at time period 5, but they are not connected at time period 10. Two locations are referred to as being “connected” if a vehicle can travel to one location from another location. Also the distance between two locations could be 2 hours if a vehicle departs at time period 5, but it is 3 hours if a vehicle departs at time period 10. For each commodity there is a required arrival time, which leads to time-window constraints.

DVRP in one embodiment of the present disclosure is designed to work in large-scale vehicle routing problems. For example, the scalability of DVRP may be as follows. The number of locations in the distributed network is more than 2,000, on average. The planning horizon is for 6 days with minutes as the time unit. The number of vehicles is more than 1,000, on average. The total number of delivery commodities is more than 4,000 truckloads, on average. Differences between DVRP and the typical vehicle routing problem include (1) DVRP has no transportation cost restriction, and (2) DVRP's objective of demand satisfaction with fairness. Instead of minimizing routing cost or traveling time, DVRP considers demand satisfaction with fairness. Applications of this include disaster response and supply chain operation in a competitive environment.

Four algorithms are disclosed for DVRP. An exact algorithm for cases with low demand, a greedy algorithm, a greedy algorithm with local improvement, and a column generation approach. The exact algorithm produces an exact solution when the demand of truckloads is less than the number of available trucks. The greedy algorithm is the fastest algorithm for DVRP in the general setting. The greedy algorithm with local improvement utilizes local search techniques to improve the precision of the greedy solution. The column generation method uses the greedy algorithm as a subroutine and provides the best approximation to the optimal solution.

The output of DVRP is vehicle routings and commodity pickup and delivery schedules.

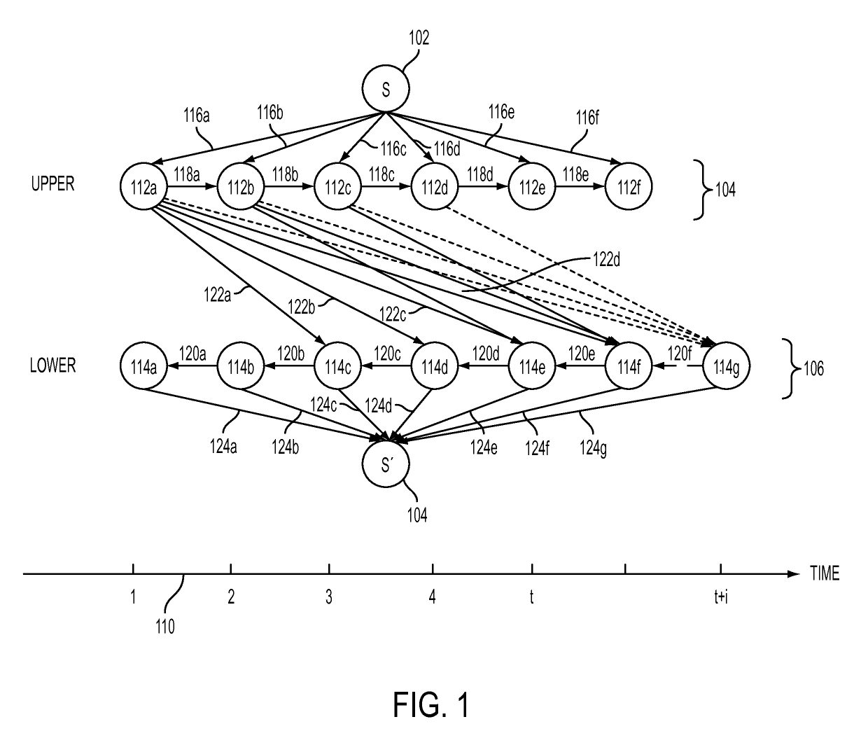

FIG. 1 illustrates an example of a network for the low demand case. A low demand case refers to a supply chain network in which the demand level is lower than the amount transportable by the available number of vehicles. FIG. 1 shows in one embodiment a pickup and delivery problem being modeled as a network flow problem. s 102 represents the source, and s′ 104 represents the sink. The example in FIG. 1 shows the case where there is one upper level location and one lower level location. It should be understood, however, that many levels may exist. If many levels exist, they may be considered pairwise as shown in FIG. 1. Also, many locations may exist per level. Referring to FIG. 1, each node (112a, 112b, 112c, 112d, 112e, 112f) in the upper level 106 represents the same location (an upper level location), but at a different time t, as indicated by the time axis 110. Similarly, each node (114a, 114b, 114c, 114d, 114e, 114f, 114g) in the lower level 108 represents the same lower level location. The source s 102 has an arc (116a, 116b, 116c, 116d, 116e, 116f) to every node (112a, 112b, 112c, 112d, 112e, 112f) in the upper level 106, referred to in the present disclosure as the supply arcs. The upper level nodes (112a, 112b, 112c, 112d, 112e, 112f) then each have an arc (referred to in the present disclosure as the upper level inventory arcs) to the next node in the upper level, corresponding to the same location, but in the next time period. Upper level inventory arcs are shown at 118a, 118b, 118c, 118d, 118e. The upper level nodes (e.g., 112a, 112b, 112c, 112d) also have arcs (representing shipment possibilities) to all nodes in the lower level (114c, 114d, 114e, 114f, 114g) that are offset in time from the upper level node by greater than or equal to a certain amount, i.e., offset time that is greater than equal to the travel time. The lower level nodes all have an arc (120a, 120b, 120c, 120d, 120e, 120f) to the previous node, referred to in the present disclosure as the lower level inventory arcs. Each lower level node has an arc (124a, 124bb, 124c, 124d, 124e, 124f, 124g), referred to in the present disclosure as the demand arcs, to the sink 104.

Example problem description and methodologies for solutions follow.

Problem Description

The total time horizon for DVRP, denoted by T, is a time duration. In this example, it can be 72 hours or 144 hours. The time horizon is discretized to time points from 1 to T with intervals, in this example, 1, 5, 10, or 30 minutes as possible time intervals. Because the connectivity and distance in the transportation network is time-dependent, DVRP re-optimizes the vehicle routing problem every time period—in this example, 3 or 6 hours.

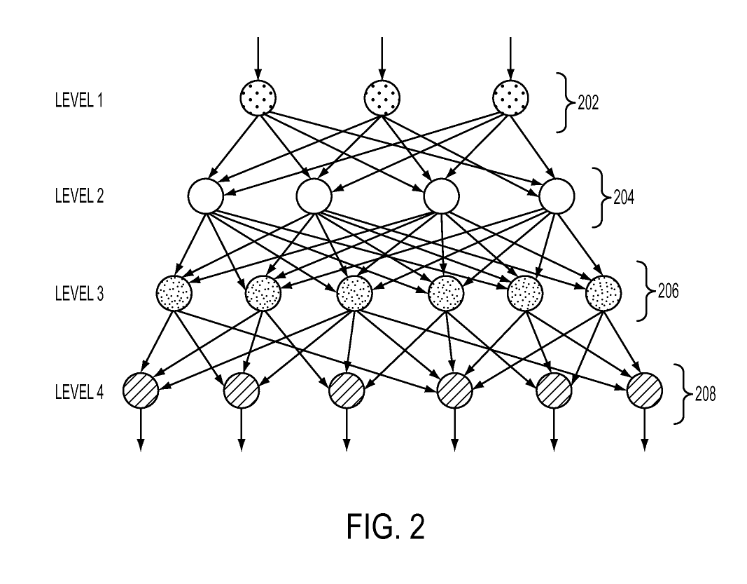

We take four-level networks as an example to demonstrate the whole system of DVRP as follows. FIG. 2 illustrates the distribution network for this example. In the figure, the nodes at each level represent different locations at that level. The top level locations 202 have an available inventory for each time t. The second level locations 204 have commodity requests as the demand, for each time t. Vehicles located at vehicle depots corresponding to the first level locations deliver available commodities from the first level locations 202 to satisfy demand at the second level locations 204. The arrived commodities to a second level location 204 at time period t and remaining inventory in this location are available for further shipment from the location 204 at time period t. Vehicles, located at vehicle depots corresponding to the second level locations, deliver inventory from the second level locations 204 to the third level locations 206. Vehicles, located at vehicle depots corresponding to the third level locations, deliver inventory from the third level locations 206 to the forth level locations 208. Each vehicle has an initial availability time from which it can start shipping the shipments. Thus vehicles starting at a location in level k only travel between locations in level k and locations in level k+1. The trucks pickup one truck load at a location in level k and deliver the entire truck load to a location in level k+1. The vehicle then goes to another location in level k to pickup another truck load, and so on. Thus a route for one vehicle includes a sequence (l₁,t₁), (l₂,t₂), . . . , (l₂ₚ₊₁,t₂ₚ₊₁), where l₂ᵢ₊₁ is a location in level k, 0≦i≦p, p representing the number of pickups; l₂ⱼ is a location in level k+1, 1≦j≦p; and tᵢ is the arrival time at location lᵢ. The demand satisfaction is evaluated at the bottom level (e.g., 208). Each location from the lower levels has a demand for each time t. Demand at time t can be satisfied by delivered commodities at time t or earlier.

We consider the objective function with fairness, which can be formulated in the following way:

$$min {\sum }_{j ; t ∈ T}^{ } \{ {0.2 [ {u}_{jt} - {d}_{jt} / 2 ]}^{+} + {u}_{jt} \} \qquad ( 1 )$$

Here, uⱼᵢ represents the unsatisfied demand at location j at time t, and dⱼᵢ represents the demand at location j at time t. The objective function in Equation (1) provides a linear fairness judgment; if the unsatisfied demand is more than half of the demand, we add a penalty of 0.2uⱼᵢ; otherwise, it will be just the value uⱼₜ. The purpose of this penalty in one embodiment of the present disclosure is to avoid concentrating the unsatisfied demand in any particular location. We have stated this objective in terms of unsatisfied demand, which is equivalent to maximizing demand satisfaction with fairness.

More generally, equation (1) may be expressed as

$$min {\sum }_{j ; t ∈ T}^{ } \{ {A [ {u}_{jt} - {d}_{jt} / B ]}^{+} + {u}_{jt} \}$$

wherein A is a value representing a penalty coefficient and B is a value that determines a threshold of unsatisfied demand for imposing the penalty.

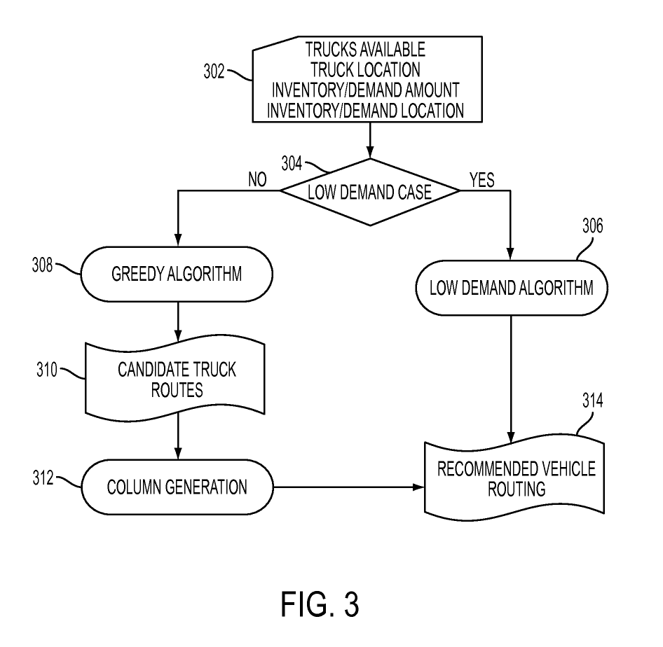

In the present disclosure in one embodiment, four algorithms for DVRP are disclosed, the exact solution approach for low demand cases, the greedy algorithm, the greedy algorithm with local improvement, and column generation. Each of these algorithms deals with two-level networks, if the network has k levels, we apply a two-level algorithm k−1 times. FIG. 3 illustrates the algorithm design in one embodiment of the present disclosure for dynamic vehicle routing in multistage distribution networks with multiple sourcing and delivery constraints. Input to the algorithms shown at 302 may include the availability of transportation vehicles, such as trucks and their current location, inventory and demand amounts at every location, and relationships between locations, e.g., their position in the distribution network such as their level in the supply and demand network, and how each location is connected to other locations in the transportation network, such as the traveling time to other locations in the network. At 302, it is determined whether a scenario for which an inventory routing is desired to be calculated is a low demand case. At 304, if it is a low demand case, a low demand algorithm may be applied at 306. In the low demand case, all demand is satisfied, therefore, fairness is automatically achieved. The algorithm at 306 produces a plan of recommended vehicle routing at 314. If at 304, it is determined that the case is not a low demand case, another algorithm, for example, a greedy algorithm, is applied at 308. The candidate vehicle route 310 produced by the greedy algorithm may be used to apply a column generation algorithm at 312. The column generation algorithm outputs a recommended vehicle routing plan 314. In each of the algorithms, fairness is satisfied by the objective function shown in Equation (1). In one embodiment of the present disclosure, the objective function gives preference to solutions which do not vary too much in their demand satisfaction at different locations.

Those algorithms are described as follows.

Exact Solution Approach for Low Demand

The exact solution approach is for a special case of DVRP. Here we treat a two-level network. We assume that for each location of the first level, and for each time, there are enough vehicles to ship the entire supply. We name this case as the low demand case.

This low demand case may be modeled as a maximum flow problem, e.g., as follows. For the upper level we have nodes (iᵤ,t), where iᵤ denotes an upper level location, and t is a time. For the lower level we have nodes (jₗ, t); here jₗ denotes a lower level location and t is a time. We also have a source node denoted by s and a sink node denoted by ω.

Now we describe the arcs of this network.
We have supply arcs [s→(iᵤ,t)] whose capacity is the supply amount arriving to iᵤ at time t and denoted by cᵢ_{ᵤ}_{,t}⁸. See, e.g., FIG. 1 at 116a, 116b, 116c, 116d, 116e, 116f. The flow on this arc is denoted by xᵢ_{ᵤ}_{,t}^{s}.
We also have demand arcs [(jₗ,t)→ω] whose capacity is the demand of location jₗ at time t and is denoted by c_{w}^{j}^{ₗ}^{,t}. See, e.g., FIG. 1 at 124a, 124bb, 124c, 124d, 124e, 124f, 124g. The flow on this arc is x_{w}^{j}^{ₗ}^{,t}
Then we have arcs connecting node (iᵤ,t₁) with (jₗ,t₂) with t₂≧t₁+d(iᵤ,jₗ), where d(iᵤ,jₗ) is the traveling time from iᵤ to jₗ. See, e.g., FIG. 1 at 122a, 122b, 122c, 122d. The flow on this arc is denoted by xⱼ_{ₗ}_{,t}_{₂}ⁱ^{ᵤ}^{,t}^{₁}. This is for all possible values of t₁. They have infinite capacity.
We also have inventory arcs connecting nodes (iᵤ, t) and (iᵤ,t+1), for all values of t. See, e.g., FIG. 1 at 118a, 118b, 118c, 118d, 118e. They have infinite capacity and the flow on them is the inventory that carries over from t to t+1. The flow on this arc is xₜ_{ᵤ}_{,t+1}ⁱ^{ᵤ}^{,t}.
And at the lower level we also have inventory arcs connecting nodes (jₗ,t+1) and (jₗ,t), for all values of t. See, e.g., FIG. 1 at and 120a, 120b, 120c, 120d, 120e, 120f. They have infinite capacity and the flow on them is the inventory that carries over from t to t+1, to satisfy later demand. The flow on this arc is xⱼ_{ₗ}_{,t}^{j}^{ₗ}^{t+1}.

Let U be the set of upper level locations, L the set of lower level locations, and T the set {1, . . . , T}. We solve the following:

$$\begin{matrix}{max}_{x} {\sum }_{{t}_{u} ∈ U , t ∈ T}^{ } {x}_{{i}_{u} , t}^{s} & ( 2 ) \\ s . t . {x}_{{i}_{u} , t}^{s} + {x}_{{i}_{u} , t}^{{i}_{u} , t - 1} = {x}_{{i}_{u} , t + 1}^{{i}_{u} , t} + {\sum }_{{j}_{𝓁} ∈ L , τ \geq t + {d}_{{j}_{𝓁}}^{{i}_{u}}}^{ } {x}_{{j}_{𝓁} , τ}^{{i}_{u} , t} , \\ {i}_{u} ∈ U , t ∈ T & ( 3 ) \\ {x}_{{j}_{𝓁} , t}^{{j}_{𝓁} , t + 1} + {\sum }_{{i}_{u} ∈ U , {t}^{′} \leq t - {d}_{{j}_{𝓁}}^{{i}_{u}}}^{ } {x}_{{j}_{𝓁} , t}^{{i}_{u} , t} = {x}_{{j}_{𝓁} , t - 1}^{{i}_{𝓁} , t} + {x}_{ω}^{{i}_{𝓁} , t} , \\ {j}_{u} ∈ L , t ∈ T & ( 4 ) \\ {x}_{{i}_{u} , t}^{s} \leq {c}_{{i}_{u} , t}^{s} , {i}_{u} ∈ U , t ∈ T & ( 5 ) \\ {x}_{ω}^{{j}_{𝓁} , t} \leq {c}_{ω}^{{j}_{𝓁} , t} , {j}_{𝓁} ∈ L , t ∈ T & ( 6 ) \\ x \geq 0. & ( 7 )\end{matrix}$$

The above linear program can be treated as a maximum flow problem. Let x* be an integer optimal solution. We derive a routing of the vehicles as follows. The initial location of vehicles and vehicle assignment is given by x*ᵢ_{ᵤ}_{,t}^{s} with iᵤεU,tεT. The routing of vehicles is given by x*ⱼ_{ₗ}_{,τ}ⁱ^{ᵤ}^{,t} with iᵤεU, jₗεL, t, τεT.

Since this example describes a low demand case, all demand is satisfied, achieving the desired fairness. Equation (2) above maximizes the total flow coming out from the source node, which is in turn the total flow going through the network. This in turn is equivalent to the total amount of demand being satisfied (which will equal total demand since this is a low demand case). Equation (3) above represents the flow conservation constraint for the upper level nodes specifying that the flow into each upper level node equals the flow out. Equation (4) represents another flow conservation constraint for the lower level nodes specifying that the flow into each lower level node equals the flow out. Equations (5) and (6) represent that the flow on any arc cannot exceed the capacity of the arc, which in this example represents that the amount delivered does not exceed the amount supplied or demanded. Equation (7) represents that there are no negative flow on any arc.

Next, we discuss how to solve DVRP in a more general setting by a greedy algorithm and by column generation. In the general setting, each vehicle is available at an arbitrary time period within the time horizon. Moreover, there is no relationship between the number of vehicles and inventory or demand levels.

Greedy Algorithm

The greedy algorithm in one embodiment develops a fast and flexible algorithm. We assume that we have a two-level network. In this example, we have one list to record the inventory level at each upper-level location and for each time. We also have one list to record the demand level of every lower-level location and at each time. At each iteration we send a truck (or another transportation vehicle or medium) from an upper-level location to a low-level location, and then back to an upper-level location. To choose which truck to send, we compute for each truck the shortest two-step trip, and then choose a truck that after this two-step trip would have the minimum total traveling time. At each iteration we update the inventory and demand of the chosen locations. The procedure iterates until all demand is assigned or all trucks have reached a time limit. The inventories and demands are given in the input. Also each vehicle's first available time and location are given in the input.

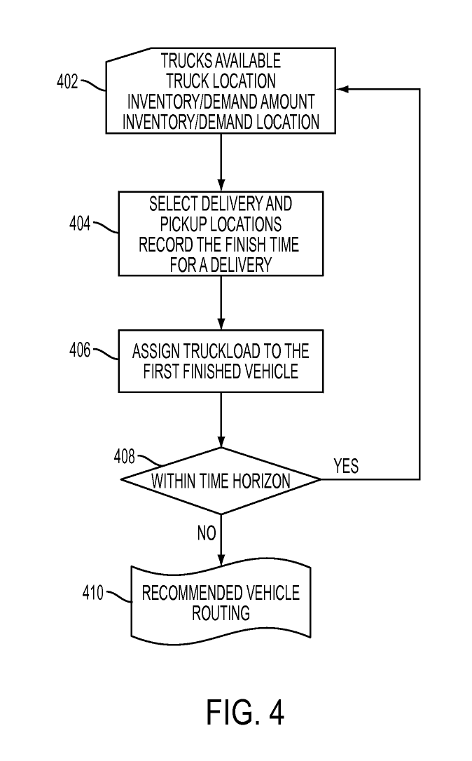

FIG. 4 illustrates this algorithm in one embodiment of the present disclosure. Available vehicles and their location, inventory and demand amount at locations and identities of those locations are input or received at 402. At 404, for each truck, all its possible routes are considered, and the corresponding delivery times are recorded. At 406, the truck with the minimum of these delivery times is chosen, and is assigned the corresponding route. Inventory and demand are then updated based on the inclusion of this route. When this completes, if the truck has reached its time limit, it is no longer considered in the process. The process repeats until all demand is satisfied or all the trucks have reached their time limit. At 408, if there is more demand to meet and available trucks, the process returns to 402. Otherwise, at 410, recommended vehicle routing is output. To determine fairness or the coverage of demand in the recommended vehicle routing plan 410, the solutions may be compared with a desired plan. The recommended vehicle routing plan 410 output from the algorithm may be also compared with solutions of other algorithms whose objective function considers fairness.

Table 1 describes the notations used in the example greedy algorithm in one embodiment of the present disclosure. The example greedy algorithm is illustrates in Table 2.

TABLE 1
Notations for greedy algorithm

| Notation | Description |
|---|---|
| N | total demand |
| n | total unsatisfied demand |
| I | total number of the upper level locations |
| J | total number of the lower level locations |
| C | the total number of vehicles |
| vᵢₜ | the cumulative inventory level in the upper level |
| | location i at time t |
| uⱼₜ | the cumulative demand request in lower level location |
| | j at time t |
| dᵢⱼ | the distance between location i and location j |
| τ_{c} | the available time of vehicle c |
| η_{c} | the location of vehicle c |
| M | the shortest time span for vehicle c to deliver a new |
| | workload to location j, j = 1, . . . , J |
| E | the shortest time span for vehicle c to finish a new |
| | workload |
| Q | the shortest time span for the whole system to finish |
| | a new workload |
| W | the time of a vehicle arriving in location j when the |
| | whole delivery ends at Q |
| lᵢ | the loading time of a workload in the upper level |
| | location i |
| βⱼ | the unloading time of a workload in the lower level |
| | location j |

TABLE 2
Greedy algorithm

Initialization

Set the remaining workloads n = N .
Set the initial inventory in location i at time t , vᵢₜ , as inputs with

i = 1,...,I , t = 1,...,T .

Set the request demand in location j at time t , uⱼₜ , as inputs with

j = 1,...,J , t = 1,...,T .

Set the first available time, τ_{c} , and initial location, η_{c} , of

vehicles as inputs with c = 1,...,C .

Sort vehicles by the first available time.

Iteration

For remaining workloads n , let Q = T .
For vehicle c with c = 1,...,C ,

Decide the earliest time demand request in location n_{c} .

k(c) = min{t : t ≧ τ_{c},v_{η}_{_{c}}ₜ > 0} .

Select deliver location j* .
M = min_{j=1,...,J} {max{ {k(c) + d_{η}_{_{c}}ⱼ + l_{η}_{_{c}} + βⱼ_{},min{t :}
uⱼₜ > 0} } }

j* = arg min_{j=1,...,J} {max{ {k:(c) + d_{η}_{_{c}}ⱼ + l_{η}_{_{c}} +
βⱼ},min{t : uⱼₜ > 0} } }

Decide the earliest available inventory in location i with
i = 1,...,I .

e(i) = min{t : t ≧ M + dⱼ_{^{*}}ₜ, vᵢₜ > 0}.

Select pickup location.

E = min_{i=1,...,I} {e(0)}.
i* = arg min_{i=1,...,I} {e(i)}.

If Q > E , Q = E , W = M , c* = c , i_{c}_{^{*}} = i* , j_{c}_{^{*}} = j* .

Update vehicle information, η_{c}_{^{*}} = i_{c}_{^{*}} and τ_{c}_{^{*}} = Q .
Update inventory and demand information, vᵢ_{^{*}}_{Q} = vᵢ_{^{*}}_{Q} − 1,
uⱼ_{^{*}}_{W} = uⱼ_{^{*}}_{W} − 1.

If Q > T , terminated; otherwise, n = n − 1, continue.

The greedy algorithm with local improvements

We illustrate the description of the algorithm for a two layered network but it can be extended for a general network with k layers. We partition the time horizon into the time intervals corresponding to the granularity of the of demand targets, e.g., a 72 hour time horizon partitioned into 6 or 3 hour time intervals. We are also given the granularity of time which was, in testing, chosen to be 5 minutes but it could be fixed to be any number.

The algorithm in one embodiment of the present disclosure includes two phases. On the first phase the algorithm delivers inventory from the first level of the network to the second level and on the second phase the algorithm delivers inventory from the second level to the third one. The algorithm may work slightly differently when going from the first level of the network to the second level than it does when going from the second level to the third level, because in the top level to second level part of the algorithm, inputs may be entirely external, while second level to third level some of the inputs come from the top level to second level part of the algorithm.

On the first phase of the algorithm, for each time interval starting with the earliest one we randomly permute the set of vehicles. We repeat the following greedy procedure for each vehicle in the random list.

1. check if the current route end time is still within the time interval of interest, if not we stop considering the vehicle and move to the next vehicle on the list;

2. if the vehicle is located on the first level of the network with some inventory then pickup the inventory and move to the closest location on the second level;

3. if there is no inventory in that location move to the closest location on the first level with some inventory;

4. if there is no inventory anywhere on the first level or the locations with inventory are unreachable then wait at the current location for the next inventory update;

5. if the truck is located in a depot move to the closest location on the first level;

6. if the truck is located at the second level node (location), move to the closest node on the first level with some inventory; if such nodes do not exists or are unreachable then move to the closest node on the first level.

The objective function shown in Equation (1) provides a way to evaluate solutions based on how well they satisfy demand. The above greedy algorithm with local improvements produces a candidate solution which we can evaluate using the objective function (e.g., restricted to the second level nodes for this part of the algorithm). The algorithm then keeps the solution if based on the objective function it is the best found so far. For example, in the end of the above algorithm, the routes for all trucks during one time interval have been determined. We compare the value of the objective function resulting from the routes with a current record, and if the solution is better we choose the new solution as the current record. We choose a new random permutation of trucks, discard the solution and try to repeat this procedure. In the end after repeating this extension a few times we choose the current record solution and we move to the next time interval and repeat the randomized local improvement step.

The solution that is built by the above algorithm delivers the inventory to the nodes (locations) on the second level. We keep track of when the inventory was delivered with time granularity, e.g., granularity of 5 minutes (or any other time frame, e.g., the smallest time frame chosen in the beginning of the algorithm). A difference between implementation of the algorithm for the second level is that inventory availability is dynamic during one time interval. The part of the algorithm going from the second level to the third level differs from first level to second level in that, in the first level, inventory levels are fixed during the time interval (e.g., 3 or 6 hours), but in the second level, these inventory levels may no longer be fixed in this time interval, as deliveries coming down from the first level may come at any point. Thus, checks are made during the time interval in one embodiment of the present disclosure.

Column Generation

Here we develop a column generation approach for routing. In one embodiment of the present disclosure, we use the greedy algorithm as a subroutine that generates possible routings, then these routings are used in an integer program that chooses the best combination.

In order to produce different routings, we modify the greedy algorithm as follows. At each iteration of the greedy algorithm, instead of choosing a truck with minimum total traveling time, we choose at random a truck among the k lowest traveling times. Here k may be any value determined to be reasonable, for instance, for keeping the problem to a reasonable size. In the present example, k is a parameter that takes the values 3 or 4. This randomization allows us to generate many different good routings that will be given to the column generation procedure.

We let Γ be the collection of all generated routings and N be the total number of vehicles which we can use in this two-level problem. V (h) is the set of routes that is generated for vehicle h by the greedy algorithm. U is the index set of upper level locations. L is the index set of lower level locations. The set {1, . . . , T} is denoted by T. We denote by lᵢₜ the inventory arriving at location i at period t, iεU, tεT. The demand at location j at period t is denoted by dⱼₜ, jεL, tεT.

The variables of the integer program are as follows.
For each route r we have a binary variable xᵣ. It takes the value one if the route is chosen, and zero otherwise.
The variable oᵢₜ represents the inventory at location i and period t that is left at this same location for period t+1.
The variable bⱼₜ is the inventory at location j and period t left at this location to satisfy demand at later periods.
We use uⱼₜ¹ and uⱼₜ², to represent the unsatisfied demand at location j at time t. The second variable uⱼₜ² has a higher cost, and uⱼₜ¹≦dⱼₜ/2 in one embodiment of the present disclosure. This is to impose fairness in the objective. It should be understood that different penalty values may be used to impose fairness via the objective function. For instance, the value of increased penalty may differ from the exact value specified in equation (8); e.g., the coefficient value “1.2” associated with u_{j,t}² may be a different value, and uⱼₜ¹ may be a different fraction of demand dⱼₜ. In general, uⱼₜ¹+uⱼₜ²=unsatisfied demand at location j at time t, wherein uⱼₜ¹ is the portion that is less than or equal to the predetermined fraction of the demand.

Then we solve:

$$\begin{matrix}min {\sum }_{j ∈ L}^{ } {\sum }_{t ∈ T}^{ } {u}_{j , t}^{1} + 1.2 {u}_{j , t}^{2} & ( 8 ) \\ {\sum }_{r ∈ V ( h )}^{ } {x}_{r} = 1 , h ∈ N & ( 9 ) \\ {\sum }_{r , ( i , j ) ∈ r}^{ } {x}_{r} + {o}_{it} = {𝓁}_{it} + {o}_{it - 1} , i ∈ U , t ∈ T & ( 10 ) \\ {\sum }_{r : ( j , t ) ∈ r}^{ } {x}_{r} + {u}_{jt}^{1} + {u}_{jt}^{2} + {b}_{jt - 1} = {d}_{jt} + {b}_{jt} , \\ j ∈ L , t ∈ T & ( 11 ) \\ {u}_{jt}^{1} \leq {d}_{jt} / 2 , j ∈ L , t ∈ T & ( 12 ) \\ {x}_{r} ∈ \{ 0 , 1 \} , {b}_{jt} , {u}_{jt} , {u}_{jt}^{1} , {u}_{jt}^{2} , {o}_{it} \geq 0. & ( 13 )\end{matrix}$$

The variables x that take the value one give the desired routing.

Equation (8) above minimizes unsatisfied demand; it factors in an increased penalty if a location has more than half its demand unsatisfied, hence achieving fairness. For instance, all else equal, the algorithm prefers to satisfy two locations' demands partially rather than one location's demand completely and the others' not at all. Equation (9) represents that for every vehicle, exactly one of its routes is chosen. Equation (10) is a conservation constraint, specifying that the total amount that leaves an upper level location at any time, plus what is left over for the subsequent period equals the amount arriving in the period plus whatever was left over from the previous period. Equation (11) calculates unsatisfied demand. It specifies that the total amount delivered to a lower level location at a given time, plus what was left over from previous periods to satisfy demand is equal to current demand plus whatever is reserved for next period, minus unsatisfied demand. Equation (12) defines the different parts of unsatisfied demand (e.g., for different weighting purposes in the objective function). Equation (13) indicates that the x variables take the value 1 or 0 and the rest are non-negative.

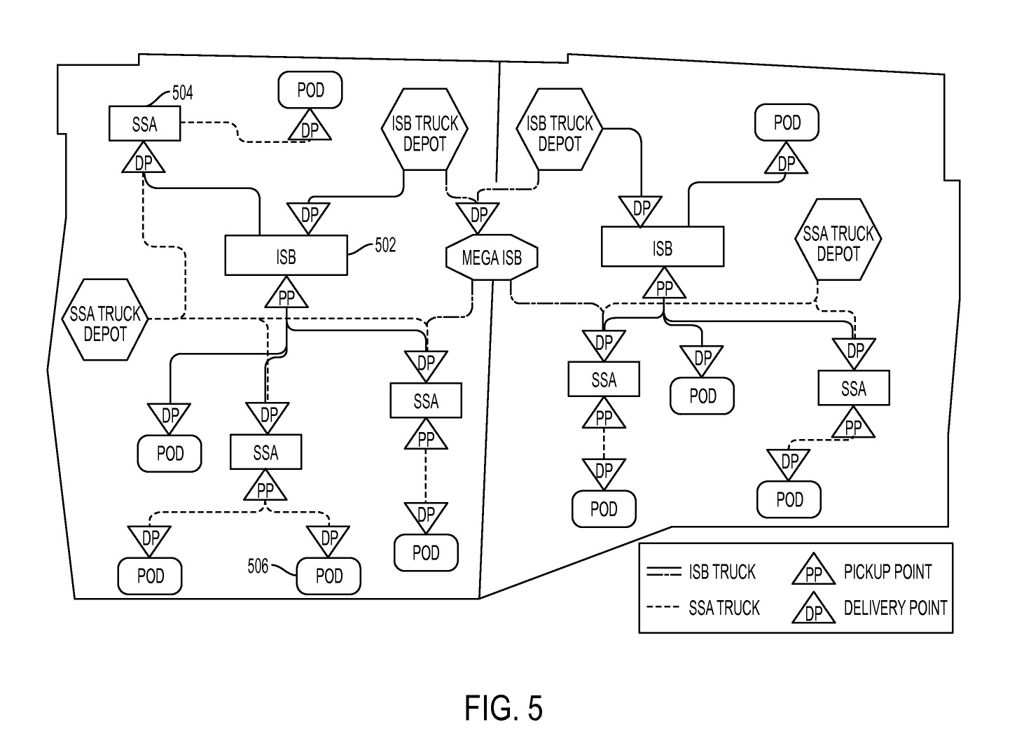

FIG. 5 illustrates an overview of an example supply chain network in which dynamic vehicle routing algorithms of the present disclosure may be applied. As described above, a transportation plan of the present disclosure obtained from the disclosed algorithms achieves predetermined inventory targets for all points in the distribution network. In the example shown in FIG. 5, incident staging bases (ISBs) 502 are examples of the first level locations (nodes), state staging areas (SSAs) 504 are examples of the second level locations (nodes) and point of distributions (PODs) 506 are examples of the bottom level locations (nodes).

Fairness in the present disclosure balances service levels among those locations. Traditional vehicle routing problem (VRP) solutions are based on a given total demand, and they minimize the transportation cost regardless of total time. They do not need to balance the service level between different locations or customers. Scenarios exist, however, where the transportation plan needs to balance the service levels (coverage) for all lower level locations (e.g., PODs 506). Coverage herein refers to satisfying demand at those locations. An example of such scenario may be in disaster response operations, in which transportation cost may be considered secondary and in which speed and fairness are prioritized.

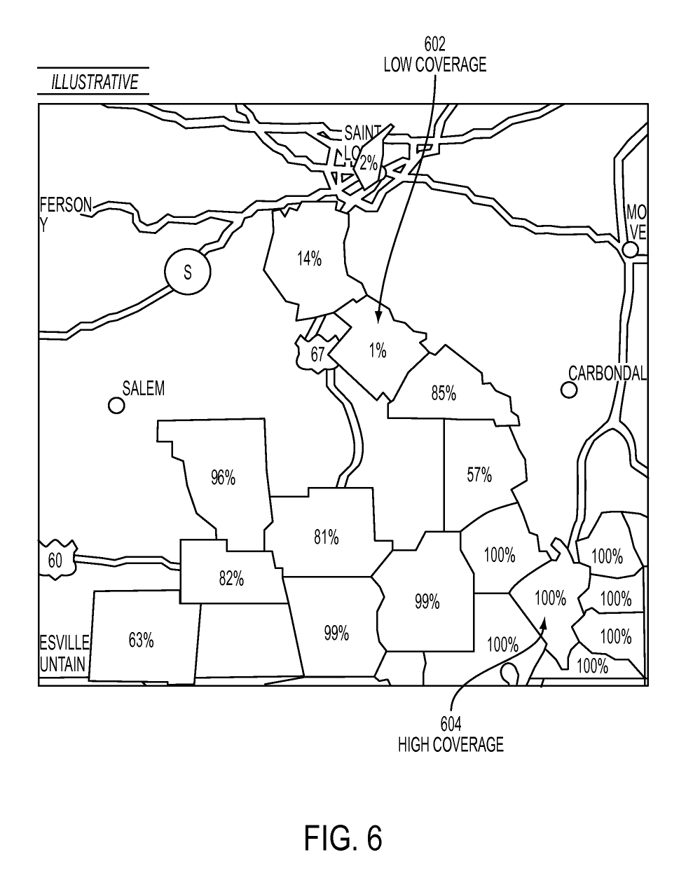

For instance, in disaster management scenarios, maximizing customer's satisfaction with an envy-free (fairness) objective function may be a transportation objective, which for example, may guarantee fairness, improve overall coverage and rescue more victims. FIG. 6 illustrates areas of coverage without fairness. In FIG. 6, sections of areas have low coverage (602), where, for example, only 1% of the demand is met or satisfied, while other sections have high coverage (604), where, for example, 100% of the demand is satisfied. In the present disclosure, the algorithms in one embodiment provide demand satisfaction with fairness, e.g., balancing the demand met across the multiple locations.

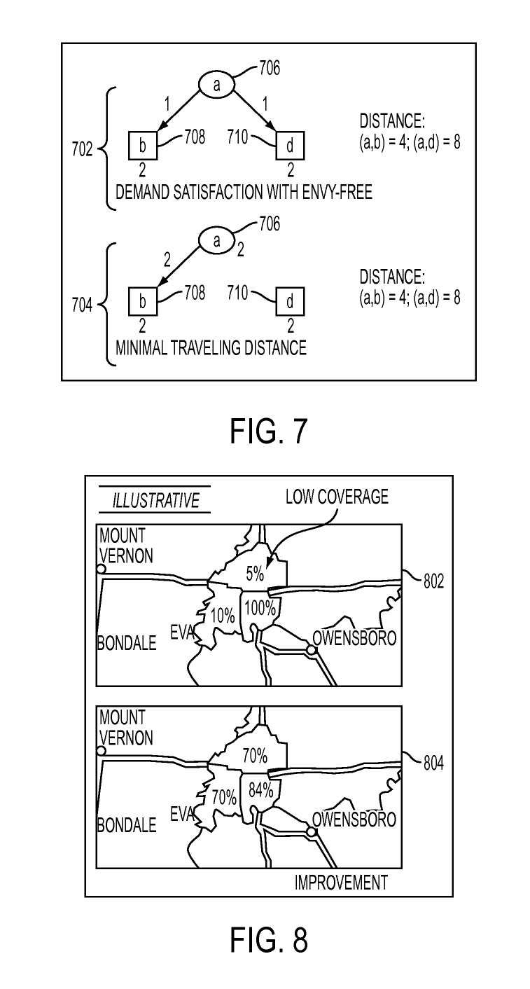

FIG. 7 illustrates the difference between solutions of supply demand problems that satisfy demand based on fairness and those that satisfy demand based on another objective, e.g., minimum travel distance. In this example, distance from location a 706 to location b 708 is 4 units; distance from location a 706 to location d 710 is 8 units. Demand amount for both locations are 2 units. In the scenario that meets demand with fairness 702, both target locations (b and d) receive deliveries; for instance, each target location receives 1 unit of shipment, regardless of the travel distance. In the scenario that meets demand based on the minimum travel distance objective function, only target location b 708 receives delivery in the amount of 2 units; target location d 710 does not receive delivery. In that scenario, the demand of only one location is met. Thus, the fairness objective function of the present disclosure in one embodiment allocates one unit to each site, even though one site is closer than the other, while an objective function that does not consider fairness, e.g., focuses on minimum travel distance, allocates two units to one site and none to the other.

FIG. 8 illustrates improvement in fairness. The low coverage in the areas shown at 802 is improved to have higher coverage at 804, e.g., from 5% demand satisfied to 70% and from 10% demand satisfied to 70%.

The transportation problem addressed in the present disclosure in one embodiment handles multiple sources of supply, multiple destinations, and multiple transshipment points in a dynamically changing supply chain. For instance, continual optimization response may be provided in a dynamic environment with time-dependent transportation time. A transportation optimizer (optimization of transportation) in the present disclosure in one embodiment is thus able to handle large scale problems in dynamic systems involving multiple source and transshipment. A large scale network, for example, can involve a network size of more than 500 locations, more than 5,000 delivery commodities, more than 3,000 vehicles and a time horizon that may be longer than a week. In dynamic systems, target demand may change or get updated continually, e.g., every few hours, and in the present disclosure in one embodiment problems can be re-optimized frequently. Also in dynamic systems, traveling distance is dynamically changed, in which the dimension of problem can be increased. Further, vehicles may be become available at different times, and in the present disclosure in one embodiment, capacity constraints change for available vehicles at different times. Multiple source and transshipment involves sourcing from multiple supplier nodes (locations), and in one embodiment of the present disclosure, capacity constraints for no-overshipping may be built in. Multi-level transshipment fulfills final targets, in which flow balance constraints build connection between different network layers. In one embodiment, the DVRP of the present disclosure may take into account all of the following criteria in planning vehicle routes: demand satisfaction with fairness (DSF), traveling time (TT), dynamic environment (DE), multiple sources (MS), time-dependent traveling time (TD), time-window constraints (TW), multiple-level networks (MLN), multiple vehicles (MV) and pickup and delivery (PD).

As described above, the transportation optimization in one embodiment of the present disclosure may utilize the following algorithms: A greedy algorithm which provides for shortest-path based heuristics with the consideration of demand satisfaction with fairness; a greedy algorithm with local improvement that improve routings based on the information associated with neighbors (transshipping nodes or locations); a column generation algorithm, which is a mixed-integer programming based approach that uses the greedy algorithm as a subroutine to generate promising candidate solution elements; and an exact algorithm for the low demand case where the demand level is lower than the available vehicle number and which may be a maximum flow based model.

A schedule of deliveries is output in one embodiment of the present disclosure for a supply chain network, the schedule providing a balance of service level between customers to manage demand satisfaction. Inputs for generating the schedule may include inventory statements, demand plans, one or more fairness business rules, vehicle plans and vehicle locations, and a description of the supply chain network and road network. Fairness business rules, e.g., may provide how the fairness objective function should be built or specified. An output schedule may be generated by applying business rules to the demand plan and by determining a transportation schedule that yields a balanced service level between locations or customers.

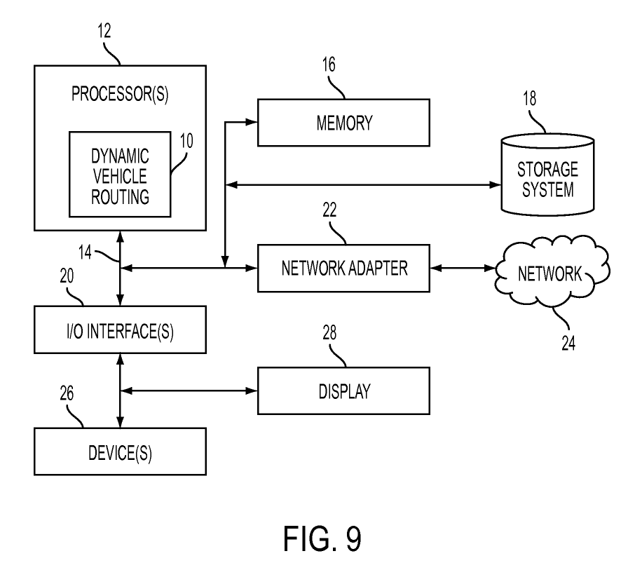

FIG. 9 illustrates a schematic of an example computer or processing system that may implement the dynamic vehicle routing system in one embodiment of the present disclosure. The computer system is only one example of a suitable processing system and is not intended to suggest any limitation as to the scope of use or functionality of embodiments of the methodology described herein. The processing system shown may be operational with numerous other general purpose or special purpose computing system environments or configurations. Examples of well-known computing systems, environments, and/or configurations that may be suitable for use with the processing system shown in FIG. 9 may include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computer system may be described in the general context of computer system executable instructions, such as program modules, being executed by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of computer system may include, but are not limited to, one or more processors or processing units 12, a system memory 16, and a bus 14 that couples various system components including system memory 16 to processor 12. The processor 12 may include a dynamic vehicle routing module 10 that performs the methods described herein. The module 10 may be programmed into the integrated circuits of the processor 12, or loaded from memory 16, storage device 18, or network 24 or combinations thereof.

Bus 14 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system may include a variety of computer system readable media. Such media may be any available media that is accessible by computer system, and it may include both volatile and non-volatile media, removable and non-removable media.

System memory 16 can include computer system readable media in the form of volatile

memory, such as random access memory (RAM) and/or cache memory or others. Computer system may further include other removable/non-removable, volatile/non-volatile computer system storage media. By way of example only, storage system 18 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 14 by one or more data media interfaces.

Computer system may also communicate with one or more external devices 26 such as a keyboard, a pointing device, a display 28, etc.; one or more devices that enable a user to interact with computer system; and/or any devices (e.g., network card, modem, etc.) that enable computer system to communicate with one or more other computing devices. Such communication can occur via Input/Output (I/O) interfaces 20.

Still yet, computer system can communicate with one or more networks 24 such as a local area network (LAN), a general wide area network (WAN), and/or a public network (e.g., the Internet) via network adapter 22. As depicted, network adapter 22 communicates with the other components of computer system via bus 14. It should be understood that although not shown, other hardware and/or software components could be used in conjunction with computer system. Examples include, but are not limited to: microcode, device drivers, redundant processing units, external disk drive arrays, RAID systems, tape drives, and data archival storage systems, etc.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of foams, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages, a scripting language such as Perl, VBS or similar languages, and/or functional languages such as Lisp and ML and logic-oriented languages such as Prolog. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The computer program product may comprise all the respective features enabling the implementation of the methodology described herein, and which—when loaded in a computer system—is able to carry out the methods. Computer program, software program, program, or software, in the present context means any expression, in any language, code or notation, of a set of instructions intended to cause a system having an information processing capability to perform a particular function either directly or after either or both of the following: (a) conversion to another language, code or notation; and/or (b) reproduction in a different material form.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Various aspects of the present disclosure may be embodied as a program, software, or computer instructions embodied in a computer or machine usable or readable medium, which causes the computer or machine to perform the steps of the method when executed on the computer, processor, and/or machine. A program storage device readable by a machine, tangibly embodying a program of instructions executable by the machine to perform various functionalities and methods described in the present disclosure is also provided.

The system and method of the present disclosure may be implemented and run on a general-purpose computer or special-purpose computer system. The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, and/or server. A module may be a component of a device, software, program, or system that implements some “functionality”, which can be embodied as software, hardware, firmware, electronic circuitry, or etc.

The embodiments described above are illustrative examples and it should not be construed that the present invention is limited to these particular embodiments. Thus, various changes and modifications may be effected by one skilled in the art without departing from the spirit or scope of the invention as defined in the appended claims.

We claim:

1. A method of determining a routing of vehicles for pickup and delivery in a supply chain network, comprising:
generating, by a processor, a plurality of candidate set of routes for vehicles for pickup and delivery to meet demand at multiple target locations;
determining unsatisfied demand at said multiple target locations resulting from completing pickup and delivery according to said plurality of candidate set of routes;
selecting a set of vehicles routes from said plurality of candidate set of routes that minimizes said unsatisfied demand across all said multiple target locations by applying an optimization function.

2. The method of claim 1, wherein the optimization function minimizes unsatisfied demand across all said multiple target locations over multiple time periods.

3. The method of claim 2, further including outputting a vehicle routing plan that specifies vehicle schedule and assignment for a plurality of vehicles utilized for pickup and delivery to said multiple target locations over said multiple time periods.

4. The method of claim 1, the generating steps applies one or more of greedy algorithm, greedy algorithm with local improvement, exact solution algorithm to determine said plurality of candidate set of routes for vehicles for pickup and delivery to meet demand at multiple target locations.

5. The method of claim 1, wherein the optimization function includes a penalty value associated with unsatisfied demand exceeding a threshold amount.

6. The method of claim 1, wherein the optimization function includes:
$$min {\sum }_{j ; t ∈ T}^{ } \{ {A [ {u}_{jt} - {d}_{jt} / B ]}^{+} + {u}_{jt} \}$$
wherein uⱼₜ represents the unsatisfied demand at location j at time t, and dⱼₜ represents the demand at location j at time t, A represents a penalty coefficient and B represents a value that determines a threshold of unsatisfied demand for imposing penalty.

7. The method of claim 1, wherein the optimization function includes:
$$min {\sum }_{j ; t ∈ T}^{ } \{ {0.2 [ {u}_{jt} - {d}_{jt} / B ]}^{+} + {u}_{jt} \} ,$$
wherein uⱼₜ represents the unsatisfied demand at location j at time t, and dⱼₜ represents the demand at location j at time t.

8. The method of claim 1, further including applying a column generation algorithm for said steps of generating and selecting, in which a greedy algorithm generates said plurality of candidate set of routes for vehicles for pickup and delivery to meet demand at multiple target locations, and said plurality of candidate set of routes are applied in an integer program that chooses best combination of routes for producing said set of vehicles routes.

9. The method of claim 8, wherein said integer program includes solving:
$$min {\sum }_{j ∈ L}^{ } {\sum }_{t ∈ T}^{ } {u}_{j , t}^{1} + 1.2 {u}_{j , t}^{2}$$
$${\sum }_{r ∈ V ( h )}^{ } {x}_{r} = 1 , h ∈ N$$
$${\sum }_{r : ( i , t ) ∈ r}^{ } {x}_{r} + {o}_{it} = {𝓁}_{it} + {o}_{it - 1} , i ∈ U , t ∈ T$$
$${\sum }_{r : ( j , t ) ∈ r}^{ } {x}_{r} + {u}_{jt}^{1} + {u}_{jt}^{2} + {b}_{jt - 1} = {d}_{jt} + {b}_{jt} , j ∈ L , t ∈ T$$
$${u}_{jt}^{1} \leq {d}_{jt} / 2 , j ∈ L , t ∈ T$$
$${x}_{r} ∈ \{ 0 , 1 \} , {b}_{jt} , {u}_{jt} , {u}_{jt}^{1} , {u}_{jt}^{2} , {o}_{it} \geq 0 , ,$$
wherein uⱼₜ¹ and uⱼₜ² represent unsatisfied demand at location j at time t,
for each route r a binary variable xᵣ takes a value one if associated route is chosen, and zero otherwise,
variable oᵢₜ represents inventory at location i and period t that is left at this same location for period t+1,
variable bⱼₜ is inventory at location j and period t left at this location to satisfy demand at later periods,
N represents the total number of vehicles,
V(h) represents a set of routes that is generated for vehicle h,
lᵢₜ represents inventory arriving at location i at period t,
dⱼₜ represents demand at location j at period t.

10. A computer readable storage medium storing a program of instructions executable by a machine to perform a method of determining a routing of vehicles for pickup and delivery in a supply chain network, comprising:
generating a plurality of candidate set of routes for vehicles for pickup and delivery to meet demand at multiple target locations;
determining unsatisfied demand at said multiple target locations resulting from completing pickup and delivery according to said plurality of candidate set of routes;
selecting a set of vehicles routes from said plurality of candidate set of routes that minimizes said unsatisfied demand across all said multiple target locations by applying an optimization function.

11. The computer readable storage medium of claim 10, wherein the optimization function minimizes unsatisfied demand across all said multiple target locations over multiple time periods.

12. The computer readable storage medium of claim 11, further including outputting a vehicle routing plan that specifies vehicle schedule and assignment for a plurality of vehicles utilized for pickup and delivery to said multiple target locations over said multiple time periods.

13. The computer readable storage medium of claim 10, the generating steps applies one or more of greedy algorithm, greedy algorithm with local improvement, exact solution algorithm to determine said plurality of candidate set of routes for vehicles for pickup and delivery to meet demand at multiple target locations.

14. The computer readable storage medium of claim 10, wherein the optimization function includes a penalty value associated with unsatisfied demand exceeding a threshold amount.

15. The computer readable storage medium of claim 10, wherein the optimization function includes:
$$min {\sum }_{j ; t ∈ T}^{ } \{ {A [ {u}_{jt} - {d}_{jt} / B ]}^{+} + {u}_{jt} \}$$
wherein uⱼₜ represents the unsatisfied demand at location j at time t, and dⱼₜ represents the demand at location j at time t, A represents a penalty coefficient and B represents a value that determines a threshold of unsatisfied demand for imposing penalty.

16. The computer readable storage medium of claim 10, wherein the optimization function includes:
$$min {\sum }_{j ; t ∈ T}^{ } \{ {0.2 [ {u}_{jt} - {d}_{jt} / 2 ]}^{+} + {u}_{jt} \} ,$$
wherein uⱼₜ represents the unsatisfied demand at location j at time t, and dⱼₜ represents the demand at location j at time t.

17. The computer readable storage medium of claim 10, further including applying a column generation algorithm for said steps of generating and selecting, in which a greedy algorithm generates said plurality of candidate set of routes for vehicles for pickup and delivery to meet demand at multiple target locations, and said plurality of candidate set of routes are applied in an integer program that chooses best combination of routes for producing said set of vehicles routes.

18. The computer readable storage medium of claim 17, wherein said integer program includes solving:
$$min {\sum }_{j ∈ L}^{ } {\sum }_{t ∈ T}^{ } {u}_{j , t}^{1} + 1.2 {u}_{j , t}^{2}$$
$${\sum }_{r ∈ V ( h )}^{ } {x}_{r} = 1 , h ∈ N$$
$${\sum }_{r : ( i , t ) ∈ r}^{ } {x}_{r} + {o}_{it} = {𝓁}_{it} + {o}_{it - 1} , i ∈ U , t ∈ T$$
$${\sum }_{r : ( j , t ) ∈ r}^{ } {x}_{r} + {u}_{jt}^{1} + {u}_{jt}^{2} + {b}_{jt - 1} = {d}_{jt} + {b}_{jt} , j ∈ L , t ∈ T$$
$${u}_{jt}^{1} \leq {d}_{jt} / 2 , j ∈ L , t ∈ T$$
$${x}_{r} ∈ \{ 0 , 1 \} , {b}_{jt} , {u}_{jt} , {u}_{jt}^{1} , {u}_{jt}^{2} , {o}_{it} \geq 0 , ,$$
wherein uⱼₜ¹ and uⱼₜ² represent unsatisfied demand at location j at time t,
for each route r a binary variable xᵣ takes a value one if associated route is chosen, and zero otherwise,
variable oᵢₜ represents inventory at location i and period t that is left at this same location for period t+1,
variable bⱼₜ is inventory at location j and period t left at this location to satisfy demand at later periods,
N represents the total number of vehicles,
V(h) represents a set of routes that is generated for vehicle h,
lᵢₜ represents inventory arriving at location i at period t,
dⱼₜ represents demand at location j at period t.

19. A system of determining a routing of vehicles for pickup and delivery in a supply chain network, comprising:
a processor operable to generate a plurality of candidate set of routes for vehicles for pickup and delivery to meet demand at multiple target locations, the processor further operable to determine unsatisfied demand at said multiple target locations resulting from completing pickup and delivery according to said plurality of candidate set of routes, the processor further operable to select a set of vehicles routes from said plurality of candidate set of routes that minimizes said unsatisfied demand across all said multiple target locations by applying an optimization function.

20. The system of claim 19, wherein the optimization function minimizes unsatisfied demand across all said multiple target locations over multiple time periods.

21. The system of claim 19, wherein the processor applies one or more of greedy algorithm, greedy algorithm with local improvement, exact solution algorithm to determine said plurality of candidate set of routes for vehicles for pickup and delivery to meet demand at multiple target locations.

22. The system of claim 19, wherein the optimization function includes a penalty value associated with unsatisfied demand exceeding a threshold amount.

23. The system of claim 19, wherein the optimization function includes:
$$min {\sum }_{j ; t ∈ T}^{ } \{ {A [ {u}_{jt} - {d}_{jt} / B ]}^{+} + {u}_{jt} \}$$
wherein uⱼₜ represents the unsatisfied demand at location j at time t, and dⱼₜ represents the demand at location j at time t, A represents a penalty coefficient and B represents a value that determines a threshold of unsatisfied demand for imposing penalty.

24. The system of claim 19, wherein the processor applies a column generation algorithm, in which a greedy algorithm generates said plurality of candidate set of routes for vehicles for pickup and delivery to meet demand at multiple target locations, and said plurality of candidate set of routes are applied in an integer program that chooses best combination of routes for producing said set of vehicles routes.

25. The system of claim 24, wherein said integer program includes solving:
$$min {\sum }_{j ∈ L}^{ } {\sum }_{t ∈ T}^{ } {u}_{j , t}^{1} + 1.2 {u}_{j , t}^{2}$$
$${\sum }_{r ∈ V ( h )}^{ } {x}_{r} = 1 , h ∈ N$$
$${\sum }_{r : ( i , t ) ∈ r}^{ } {x}_{r} + {o}_{it} = {𝓁}_{it} + {o}_{it - 1} , i ∈ U , t ∈ T$$
$${\sum }_{r : ( j , t ) ∈ r}^{ } {x}_{r} + {u}_{jt}^{1} + {u}_{jt}^{2} + {b}_{jt - 1} = {d}_{jt} + {b}_{jt} , j ∈ L , t ∈ T$$
$${u}_{jt}^{1} \leq {d}_{jt} / 2 , j ∈ L , t ∈ T$$
$${x}_{r} ∈ \{ 0 , 1 \} , {b}_{jt} , {u}_{jt} , {u}_{jt}^{1} , {u}_{jt}^{2} , {o}_{it} \geq 0 , ,$$
wherein uⱼₜ¹ and uⱼₜ² represent unsatisfied demand at location j at time t,
for each route r, a binary variable xᵣ takes a value one if associated route is chosen, and zero otherwise,
variable oᵢₜ represents inventory at location i and period t that is left at this same location for period t+1,
variable bⱼₜ is inventory at location j and period t left at this location to satisfy demand at later periods,
N represents the total number of vehicles,
V(h) represents a set of routes that is generated for vehicle h,
lᵢₜ represents inventory arriving at location i at period t,
dⱼₜ represents demand at location j at period t.
